(19) United States
(12) Patent Application Publication
(10) Pub. No.: US 2026/0340020 A1
(43) Pub. Date: Oct. 29, 2026

(54) METADATA MANAGEMENT METHODS AND APPARATUSES, ELECTRONIC DEVICES, AND STORAGE MEDIA

(71) Applicant: Beijing OceanBase Technology Co., Ltd., Beijing (CN)

(72) Inventors: Yuhui SHI, Hangzhou (CN); Lei ZHANG, Hangzhou (CN); Mingqiang ZHUANG, Hangzhou (CN); Quanwei WAN, Hangzhou (CN)

(21) Appl. No.: 19/662,732

(22) Filed: Apr. 29, 2026

(30) Foreign Application Priority Data
Apr. 29, 2025 (CN) 202510553151.8

(51) Int. Cl. G06F 16/38

(52) U.S. Cl. CPC G06F 16/38

(57) ABSTRACT

This application provides example metadata management methods and apparatuses, electronic devices, and storage media. In one example method, a database node writes metadata of each piece of data in cached data into a memory. The database node records, in the memory, feature information of the metadata of each piece of data, where the cached data is data loaded by a storage sharing layer to the database node, and the metadata records at least one piece of meta-information of corresponding data. The database node flushes the metadata to a local storage device, including obtaining metadata with same feature information, and aggregating and writing the metadata with the same feature information to the local storage device, where data corresponding to the metadata with the same feature information has a same data feature.

### CROSS-REFERENCE TO RELATED APPLICATIONS

This application claims priority to Chinese Patent Application No. 202510553151.8, filed on Apr. 29, 2025, which is hereby incorporated by reference in its entirety.

### TECHNICAL FIELD

One or more implementations of this specification relate to the field of database technologies, and in particular, to metadata management methods and apparatuses, electronic devices, and storage media.

### BACKGROUND

With the exponential growth of the data mount in the field of computers and the development of database technologies, a storage sharing approach has gradually emerged. Specifically, through establishment of a storage sharing layer and a plurality of database nodes that communicate with the storage sharing layer, user data can be stored in the storage sharing layer to be shared by a plurality of database nodes. The database node persistently caches a portion of data from the storage sharing layer locally, and provides data services externally based on the data.

The database node can record metadata of the persistently cached data in a memory to improve query efficiency for the persistently cached data. When space of the memory is insufficient, the metadata of the persistently cached data needs to be flushed to disk by the database node for persistence. In related technologies, the order and locations of the metadata on the disk are not effectively managed during such flushing of the metadata, resulting in metadata that needs to be read together being physically scattered on the disk. Consequently, reading the metadata from the disk exhibits low efficiency.

### SUMMARY

In view of this, one or more implementations of this specification provide metadata management methods and apparatuses, electronic devices, and storage media.

To achieve the above-mentioned objective, one or more implementations of this specification provide the following technical solutions:

According to a first aspect of one or more implementations of this specification, a metadata management method is proposed, and the method includes: writing metadata of each piece of data in cached data into a memory, and recording, in the memory, feature information of the metadata of each piece of data in the cached data, where the cached data is data loaded by a storage sharing layer to the database node, and the metadata is used to record at least one piece of meta-information of corresponding data; and when flushing the metadata to a local storage device, obtaining metadata with same feature information, and aggregating and writing the metadata with the same feature information to the local storage device, where data corresponding to the metadata with the same feature information has a same data feature.

In one or more possible implementations of this specification, marking, in the memory, feature information for metadata of each piece of data in the cached data includes: recording, in the memory, a mapping relationship between the feature information and a key of the metadata.

In one or more possible implementations of this specification, the aggregating and writing the metadata with the same feature information to the local storage device includes: determining part of feature information in all feature information as target feature information based on a predetermined cycling condition and feature information of metadata that is transferred from the memory to the local storage device at a previous time; and aggregating and writing all metadata corresponding to each piece of target feature information to the local storage device.

In one or more possible implementations of this specification, the aggregating and writing the metadata with the same feature information to the local storage device includes: determining part of feature information in all feature information as target feature information based on currently idle space of the memory and a data amount of metadata corresponding to each piece of feature information; and aggregating and writing all metadata corresponding to each piece of target feature information to the local storage device.

In one or more possible implementations of this specification, the aggregating and writing the metadata with the same feature information to the local storage device includes: generating a data file from the metadata with the same feature information, writing the data file to the local storage device, and recording meta-information of the data file in the memory.

In one or more possible implementations of this specification, the generating a data file from the metadata with the same feature information and writing the data file to the local storage device includes: merging all metadata corresponding to the feature information with a target data file in the local storage device to obtain a merging result, where the target data file is a data file that stores metadata already flushed to disk corresponding to the feature information, and the merging result includes metadata of a plurality of pieces of data; generating a data file from all metadata in the merging result, and writing the data file to the local storage device; and deleting the target data file, and deleting part of or all metadata corresponding to the feature information in the memory.

In one or more possible implementations of this specification, the metadata records a state, and the state includes normal and deleted; and the merging all metadata corresponding to the feature information with a target data file in the local storage device to obtain a merging result includes the following: if metadata of any data is recorded in the memory with a state of normal, and the metadata of the data is recorded in the target data file, adding the metadata of the data in the memory to the merging result; if metadata of any data is recorded in the memory with a state of normal, and the metadata of the data is not recorded in the target data file, adding the metadata of the data in the memory to the merging result; if metadata of any data is recorded in the memory with a state of deleted, and the metadata of the data is recorded in the target data file, determining that the metadata of the data does not belong to the merging result; if metadata of any data is recorded in the memory with a state of deleted, and the metadata of the data is not recorded in the target data file, adding the metadata of the data in the memory to the merging result; or if metadata of any data is not recorded in the memory, and the metadata of the data is recorded in the target data file, adding the metadata of the data in the target data file to the merging result.

In one or more possible implementations of this specification, the method further includes the following: if any data in the cached data is deleted by the database node, and the metadata of the data is recorded in the memory, updating a state of the metadata of the data in the memory from normal to deleted; and if any data in the cached data is deleted by the database node, the metadata of the data is not recorded in the memory, and the metadata of the data is recorded in the local storage device, inserting the metadata of the data into the memory, and marking a state of the metadata of the data as deleted.

In one or more possible implementations of this specification, the method further includes the following: receiving a write request used to indicate to write metadata of any data, and if the metadata of the data is recorded in the memory with a state of deleted, inserting the metadata of the data into the memory, and marking a state of the metadata of the data as normal; receiving a write request used to indicate to write metadata of any data, and if the metadata of the data is recorded in the memory with a state of normal, updating content of the metadata of the data in the memory; receiving a write request used to indicate to write metadata of any data, and if the metadata of the data is not recorded in the memory, and the metadata of the data is recorded in the local storage device, loading the metadata of the data into the memory, and updating content of the metadata of the data; and receiving a write request used to indicate to write metadata of any data, and if the metadata of the data is not recorded in the memory, and the metadata of the data is not recorded in the local storage device, inserting the metadata of the data into the memory, and marking a state of the metadata of the data as normal.

In one or more possible implementations of this specification, the feature information includes a value of the data in at least one feature dimension.

According to a second aspect of the one or more implementations of this specification, a metadata management apparatus is proposed. The apparatus is applied to a database node and includes: a feature module, configured to write metadata of each piece of data in cached data into a memory, and record, in the memory, feature information of the metadata of each piece of data in the cached data, where the cached data is data loaded by a storage sharing layer to the database node, and the metadata is used to record at least one piece of meta-information of corresponding data; and a persistence module, configured to: when flushing the metadata to a local storage device, obtain metadata with same feature information, and aggregate and write the metadata with the same feature information to the local storage device, where data corresponding to the metadata with the same feature information has a same data feature.

According to a third aspect of one or more implementations of this specification, a computer program product is provided and includes a computer program/instructions. When the computer program/instructions is/are executed by a processor, the steps of the method according to the first aspect are implemented.

According to a fourth aspect of one or more implementations of this specification, an electronic device is proposed, including: a processor; and a storage, configured to store instructions executable by the processor, where the processor implements the method according to the first aspect by running the executable instructions.

According to a fifth aspect of one or more implementations of this specification, a computer-readable storage medium is provided, where computer instructions are stored on the computer-readable storage medium, and the instructions are executed by a processor to implement the steps of the method according to the first aspect.

The technical solutions provided in the implementations of this specification can include the following beneficial effects.

In the metadata management method provided in the implementations of this specification, metadata of each piece of data in cached data is written to a memory, and feature information is marked for the metadata of each piece of data in the memory. When the metadata is being flushed to a local storage device, metadata with the same feature information is obtained, and the metadata with the same feature information is aggregated and written to a persistent storage device. Since data corresponding to the metadata with the same feature information shares the same data feature, there is a need to read the metadata with the same feature information together. Aggregating the metadata and writing the metadata to the persistent storage device can ensure a higher degree of physical locality. Compared with an existing approach of storing metadata at scattered locations, this method can significantly improve reading efficiency when reading metadata.

### BRIEF DESCRIPTION OF DRAWINGS

FIG. 1 is a schematic diagram illustrating a database system of a storage-shared architecture, according to exemplary implementations;

FIG. 2 is a flowchart illustrating a metadata management method, according to exemplary implementations;

FIG. 3 is a schematic diagram illustrating metadata in a memory, according to exemplary implementations;

FIG. 4 is a schematic diagram illustrating a data file in a local storage device, according to exemplary implementations;

FIG. 5 is a flowchart illustrating metadata persistence, according to exemplary implementations;

FIG. 6 is a schematic diagram illustrating a metadata persistence process, according to exemplary implementations;

FIG. 7 is a schematic diagram illustrating a metadata deleting process, according to exemplary implementations;

FIG. 8 is a schematic diagram illustrating a metadata writing process, according to exemplary implementations;

FIG. 9 is a schematic diagram illustrating a structure of a device, according to exemplary implementations; and

FIG. 10 is a block diagram illustrating a metadata management apparatus, according to exemplary implementations.

### DESCRIPTION OF EMBODIMENTS

Exemplary implementations are described in detail here, and examples of the exemplary implementations are presented in the accompanying drawings. When the following description relates to the accompanying drawings, unless specified otherwise, same numbers in different accompanying drawings represent same or similar elements. Implementations described in the following exemplary implementations do not represent all implementations consistent with one or more implementations of this specification. On the contrary, the implementations are merely examples of apparatuses and methods that are described in the appended claims in detail and consistent with some aspects of one or more implementations of this specification.

It is worthwhile to note that, in some other implementations, the steps of the corresponding method are not necessarily performed in the order shown and described in this specification. In some other implementations, the method can include more or less steps than those described in this specification. In addition, a single step described in this specification can be divided into a plurality of steps for description in other implementations, and a plurality of steps described in this specification can also be combined into a single step for description in other implementations.

User information (including but not limited to user device information, personal information of a user, etc.) and data (including but not limited to data used for analysis, stored data, displayed data, etc.) used in this specification are information and data that are authorized by the user or fully authorized by each party, related data needs to be collected, used, and processed by abiding by related laws and regulations and standards of a related country and region, and a corresponding operation entry is provided, so that the user chooses to perform authorization or rejection.

In a related technology, when space of a memory is insufficient, a database node usually flushes all metadata of persistently cached data in the memory into disk, or randomly selects part of the metadata to be flushed to the disk. As a result, in a subsequent service process, the database node still needs to load the part of the flushed metadata into the memory. In addition, reading efficiency during such loading is often low, thereby resulting in low loading efficiency and poor service performance.

Based on the above-mentioned technical problem, at least one implementation of this specification provides a metadata management method. In the method, when metadata of persistently cached data in a memory of a database node is flushed to disk, metadata having a need to be read together can be aggregated and written, so that reading efficiency can be improved during reading of such metadata.

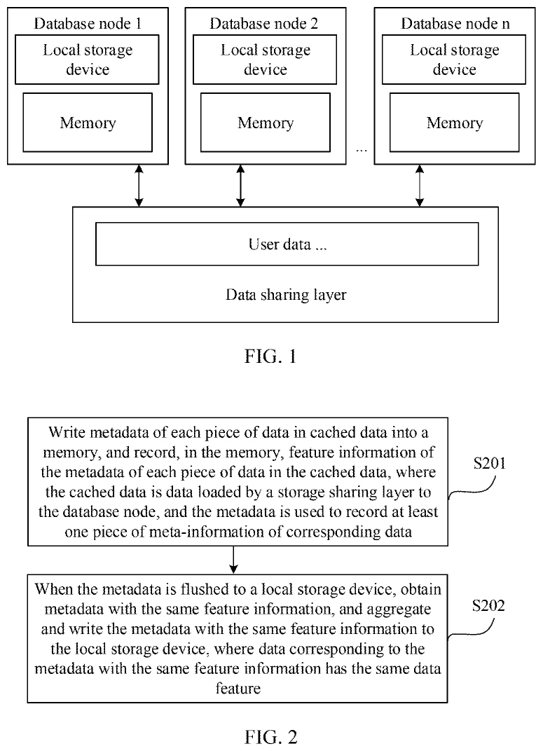

The method can be applied to a database node, such as any database node in a database system of a storage-shared architecture. Referring to FIG. 1, the database system of the storage-shared architecture can include a storage sharing layer and at least one database node communicating with the storage sharing layer, preferably a plurality of database nodes. The storage sharing layer can be in the form of object storage, etc., and stores user data and internal metadata of the system (for example, baseline data, dump data, etc.) for sharing by the plurality of database nodes. The database node has a local storage device and a memory. The local storage device is a persistent storage medium, such as a disk, and is used to persistently cache part of data in the storage sharing layer. The memory is a non-persistent storage medium, and is used to store metadata of the persistently cached data.

The data system forms a storage-compute separated architecture based on shared storage, such that data stored in the storage sharing layer not only avoids occupation of local storage space of the database nodes, but also enables data sharing among different database nodes.

Referring to FIG. 2, FIG. 2 is a flowchart illustrating the method. The method includes step S201 and step S202.

In step S201, metadata of each piece of data in cached data is written into a memory, and feature information of the metadata of each piece of data in the cached data is recorded in the memory, where the cached data is data loaded by a storage sharing layer to the database node, and the metadata is used to record at least one piece of meta-information of corresponding data.

The cached data can be loaded to a local storage device of the database node, so as to increase a data volume and stability of the cached data. Certainly, part or all of the cached data can be loaded to a memory of the database node.

For example, the feature information includes a value of the data in at least one feature dimension. For example, feature information is determined for data in the cached data by using feature dimension A and feature dimension B, that is, values a of feature dimension A are limited, values b of feature dimension B are limited, and each value a of feature dimension A and each value b of feature dimension B can form one piece of feature information. Preferably, the at least one feature dimension can be at least one field of data. For example, if the cached data has at least fields A, B, and C, field A and field B can be used as two feature dimensions, and thus, a plurality of pieces of feature information are determined accordingly. It should be understood that an identifier, such as an ID, can be allocated to each piece of feature information.

Data with the same feature information exhibits a certain commonality, namely, has the same data feature, and data with such commonality is often read simultaneously. By recording, in the memory, feature information of data corresponding to metadata, it is possible to distinguish which metadata corresponds to data with such commonality, that is, which metadata is more likely to be accessed simultaneously.

The metadata is used to describe information of the corresponding data, such as a key or a storage location. Optionally, the metadata includes a key and a value. The key is a key of the corresponding data, and the value can include content data, where the content is used to describe information of the corresponding data. In addition, the metadata can further record a state flag, for example, by recording a state in the value. The state can be normal (for example, represented by “C”) or deleted (for example, represented by “D”). Metadata with a state of normal is valid metadata, while metadata with a state of deleted represents deleted metadata, i.e., invalid metadata. It should be understood that content of a value with a state of deleted can be empty. Preferably, when the at least one feature dimension can be at least one field of the data, the key can include a plurality of fields including the at least one field serving as the feature dimension. For example, if the cached data includes at least fields A, B, and C, fields A and B can be used as two feature dimensions, and fields A, B, and C are together used as keys.

For example, feature information of metadata of each piece of data in the cached data can be recorded in the memory in the following method: recording, in the memory, a mapping relationship between feature information and a key of the metadata.

Keys of metadata corresponding to each piece of feature information form a one-to-one or one-to-many mapping relationship between feature information and keys. The mapping relationship is used to record all metadata corresponding to each piece of feature information. For example, if feature information of data corresponding to metadata having keys Key1, Key2, and Key3 is feature information ID1, Key1, Key2, and Key3 correspond to ID1; if feature information of data corresponding to metadata having keys Key4 and Key5 is feature information ID2, Key4 and Key5 correspond to ID2; if feature information of data corresponding to metadata having keys Key6 and Key7 is feature information ID3, Key6 and Key7 correspond to ID3; and if feature information of data corresponding to metadata having keys Key8 and Key9 is feature information ID4, Key8 and Key9 correspond to ID4.

Values corresponding to keys of all metadata form a one-to-one mapping relationship between the keys and the values. The mapping relationship is used to record a key-value pair of each piece of metadata. For example, if a value of metadata having Key1 is Val1, Key1 corresponds to Val1; if a value of metadata having Key2 is Val2, Key2 corresponds to Val2; if a value of metadata having Key3 is Val3, Key3 corresponds to Val3; if a value of metadata having Key4 is Val4, Key4 corresponds to Val4; if a value of metadata having Key5 is Val5, Key5 corresponds to Val5; if a value of metadata having Key6 is Val6, Key6 corresponds to Val6; if a value of metadata having Key7 is Val7, Key7 corresponds to Val7; if a value of metadata having Key8 is Val8, Key8 corresponds to Val8; and if a value of metadata having Key9 is Val9, Key9 corresponds to Val9.

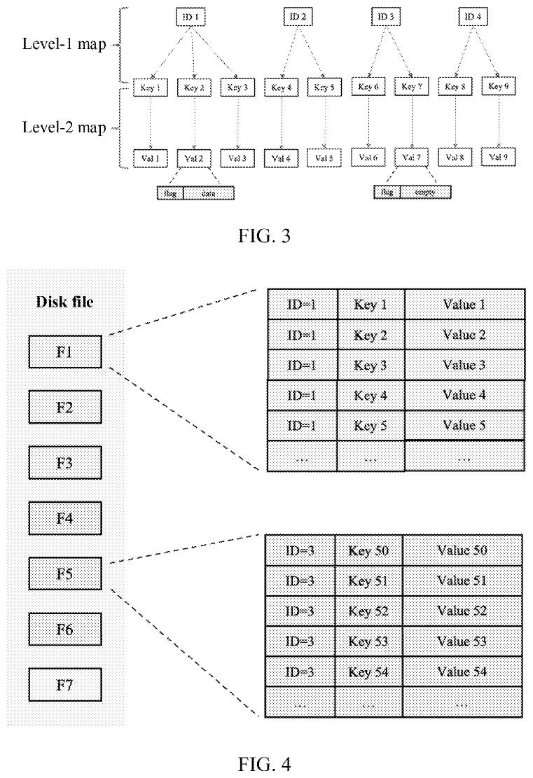

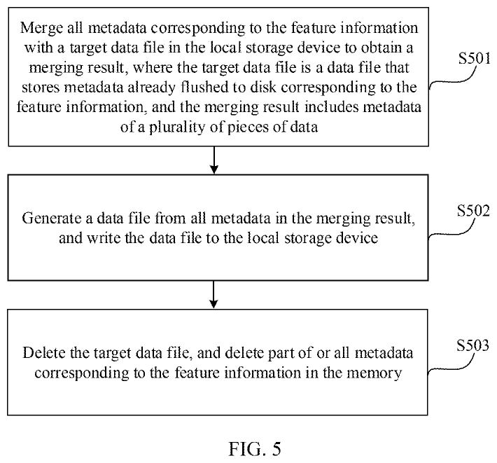

Referring to FIG. 3, the mapping relationship between the feature information and the keys, and the mapping relationship between the keys and the values, can be represented and recorded by a two-level map structure, where a level-1 map is used to represent the mapping relationship between the feature information and the keys, and a level-2 map is used to represent the mapping relationship between the keys and the values.

In step S202, when the metadata is flushed to a local storage device, metadata with the same feature information is obtained, and the metadata with the same feature information is aggregated and written to the local storage device, where data corresponding to the metadata with the same feature information has the same data feature.

Optionally, this step is performed when the memory satisfies a flush condition. The flush condition can be, for example, that idle space in the memory is less than a predetermined threshold.

In this step, part or all of the metadata of the cached data in the memory is transferred to the local storage device to achieve persistence, while releasing memory space and increasing idle space in the memory, such that metadata of subsequently continuously cached data can be successfully written to the memory.

For example, in this step, metadata having the same feature information can be used to generate one data file, the data file can be written to the local storage device, and meta-information of the data file can be recorded in the memory.

For example, the meta-information of the data file can include a file identifier Fi and a key range [Kiₘᵢₙ, Kiₘₐₓ] of all metadata in the file, where Kiₘₐₓ is a minimum value among all keys of all metadata in the file, and Kiₘᵢₙ is a maximum value among all keys of all metadata in the file. To quickly locate a file in which metadata of a certain piece of data is located, metadata that possibly stores the data can be determined based on meta-information of each data file recorded in the memory.

Metadata of data having different feature information is stored in different data files in the local storage device. That is, each data file stores all metadata corresponding to a piece of feature information, such that metadata of data having the same feature information is stored at adjacent physical addresses. Data inside the file can be sorted based on keys of metadata, so as to facilitate fast searching within the file.

Assume that each file is uniquely identified by a file identifier Fi. As such, an ordered structure (such as an ordered set or heap) can be used to store all metadata in the file (file_meta), such that all metadata is sorted based on [Kiₘᵢₙ, Kiₘₐₓ]. At the same time, a map-type container is used to manage mapping from Fi to file_meta. Through this management method of such an ordered structure plus a map-type container, all metadata can be managed in an ordered way, thereby supporting fast reading of persistent metadata.

Based on this idea, a simple implementation can be adopted: binding feature information ID of each piece of metadata to a head of a key to form {ID, Key}. During sorting, sorting is directly performed based on {ID, Key}. Such a sorting result can place all metadata having the same feature information together, and data having the same feature information is also arranged in order based on keys of the data, as shown in FIG. 4.

Key ranges of metadata stored in different data files do not overlap. That is, for any i and j, the following formula is satisfied:

∀i,j∈[1, number(files)]:[Kiₘᵢₙ, Kiₘₐₓ]∩[Kjₘᵢₙ, Kjₘₐₓ]=Ø

In the above-mentioned formula, number(files) is the number of data files.

According to the metadata management method provided in the implementations of this specification, feature information is marked in a memory for metadata of each piece of data in cached data, and when the metadata is flushed to disk, metadata with the same feature information is aggregated and written to a persistent storage device. Since data corresponding to the metadata with the same feature information shares the same data feature, there is a need to read the metadata with the same feature information together. Aggregating the metadata and writing the metadata to the persistent storage device can ensure a higher degree of physical locality. Compared with an existing approach of storing metadata at scattered locations, this method can significantly improve reading efficiency when reading metadata.

In some implementations of this specification, the above-mentioned step S202 can be alternatively performed in the following method: determining part of feature information in all feature information as target feature information based on a predetermined cycling condition and feature information of metadata that is transferred from the memory to the local storage device at a previous time; and then, separately aggregating all metadata corresponding to each piece of target feature information to the local storage device.

In the implementations, part of the feature information is selected as the target feature information in a cycling way each time metadata is persisted, and all metadata corresponding to the target feature information is flushed to disk. As described previously, the number of feature information formed by combinations of values in at least one feature dimension is limited. Thus, the cycling condition can be predetermined, for example, selecting a specific number of feature information as target feature information each time to perform metadata persistence, or selecting a specific amount of metadata in a specific order of feature information each time.

For example, if feature information such as feature information ID1, ID2, ID3, and ID4 is predetermined, the target feature information can be cyclically selected according to a condition (or rule) that two pieces of feature information are selected as the target feature information each time. If ID1 and ID2 are selected as the target feature information last time, ID3 and ID4 can be selected as the target feature information this time.

This method enables metadata corresponding to different feature information to be flushed to disk during each persistence operation, thereby ensuring balanced metadata persistence, avoiding frequent loading and persistence of metadata, and reducing I/O load.

In some implementations of this specification, the above-mentioned step S202 can be performed in the following method: First, based on current idle space of the memory and a data volume of metadata corresponding to each piece of feature information, part of all feature information is determined as target feature information. Next, all metadata corresponding to each piece of target feature information is respectively aggregated and written to the local storage device.

In the implementations, the target feature information is selected based on the data volume during each metadata persistence operation. For example, when there is relatively more idle space in the memory, feature information corresponding to a smaller amount of metadata can be selected as the target feature information; whereas when there is relatively less idle space in the memory, feature information corresponding to a larger amount of metadata can be selected as the target feature information.

This method enables precise selection of metadata to be flushed to disk during each metadata persistence operation, thereby ensuring both sufficient idle space in the memory and effective utilization of the memory.

It should be understood that, in the above-mentioned two implementations, when the metadata of the cached data is flushed to disk, part of feature information is selected from all feature information, and metadata corresponding to the selected part of feature information is flushed to disk, thereby enabling progressive flushing, and avoiding I/O load caused by full flushing, that is, reducing I/O load in a flushing process. It should be further understood that, in this method, all metadata is divided into different subsets based on the feature information, thereby facilitating the selection of part of metadata from all metadata for flushing, that is, providing a basis and convenience for progressive flushing, and further improving the efficiency of progressive flushing.

In some implementations of this specification, in the example provided in the above-mentioned step S202, the step of generating a data file from metadata having the same feature information and writing the data file to the local storage device can be performed by using the method shown in FIG. 5, including sub-steps S501 to S503.

In sub-step S501, all metadata corresponding to the feature information is merged with a target data file in the local storage device to obtain a merging result, where the target data file is a data file storing metadata already flushed to disk corresponding to the feature information, and the merging result includes metadata of a plurality of pieces of data.

The feature information can be the target feature information mentioned in the above-mentioned two implementations.

The target data file refers to a data file generated when metadata corresponding to the feature information is flushed to disk at a previous time.

As described previously, the metadata can record a state, and the state includes normal and deleted. For example, the merging processing in this step can be performed as follows: if metadata of any data is recorded in the memory with a state of normal, and the metadata of the data is recorded in the target data file, adding the metadata of the data in the memory to the merging result; if metadata of any data is recorded in the memory with a state of normal, and the metadata of the data is not recorded in the target data file, adding the metadata of the data in the memory to the merging result; if metadata of any data is recorded in the memory with a state of deleted, and the metadata of the data is recorded in the target data file, determining that the metadata of the data does not belong to the merging result; if metadata of any data is recorded in the memory with a state of deleted, and the metadata of the data is not recorded in the target data file, adding the metadata of the data in the memory to the merging result; or if metadata of any data is not recorded in the memory, and the metadata of the data is recorded in the target data file, adding the metadata of the data in the target data file to the merging result.

It should be understood that, if metadata corresponding to a plurality of pieces of feature information is flushed to disk simultaneously, the above-mentioned merging processing can be performed for each piece of feature information.

In sub-step S502, one data file is generated from all metadata in the merging result, and the data file is written to the local storage device.

It should be understood that, if metadata corresponding to a plurality of pieces of feature information is flushed to disk simultaneously, merging results of all the feature information can be further merged, and all further-merged metadata can be sorted based on feature information and keys. When the metadata in the merging result is sorted by feature information and keys, the metadata in the merging result is sequentially written to the local storage device. Each time all metadata corresponding to the same feature information has been fully written, one data file is generated. The generated data file can be added to a data structure shown in FIG. 4, and meta-information can be generated in the memory for the generated data file to record its identifier Fi and key range [Kiₘᵢₙ, Kiₘₐₓ].

In sub-step S503, the target data file is deleted, and part of or all metadata corresponding to the feature information in the memory is deleted.

This step is used to release memory space occupied by the persisted metadata, thereby increasing idle space in the memory.

For example, in a scenario in which memory space is tight or the system needs to process a large number of write requests in a short term, a large amount of idle space needs to be added in the memory, and thus all persisted metadata can be deleted to quickly release memory resources.

For another example, in a scenario in which memory space is sufficient or future write pressure of the system is low, more metadata of previously read data needs to be retained in the memory, and thus part of persisted metadata having relatively low hotness can be deleted, so as to improve a hit rate of a read operation and thereby enhance system performance.

It should be understood that, if metadata corresponding to a plurality of pieces of feature information is flushed to disk simultaneously, this step can be performed separately for each piece of feature information.

In this implementation, when metadata in the memory is persisted into the local storage device, new metadata in the memory is merged with corresponding old metadata in the local storage device, and then a merging result is written to the local storage device in the form that each piece of feature information forms one data file, while memory space is released. As such, the metadata in the local storage device can be updated to the latest state, while avoiding space waste caused by storing a plurality of versions of metadata in the local storage device.

In the implementations, one data file is generated from metadata corresponding to each piece of feature information, so that when the metadata is persisted, an aggregation operation is performed based on the feature information, and physically continuous storage is performed on a disk, which helps improve efficiency and IO performance during a metadata reading operation. In addition, a progressive persistence approach is more flexible and convenient than full persistence.

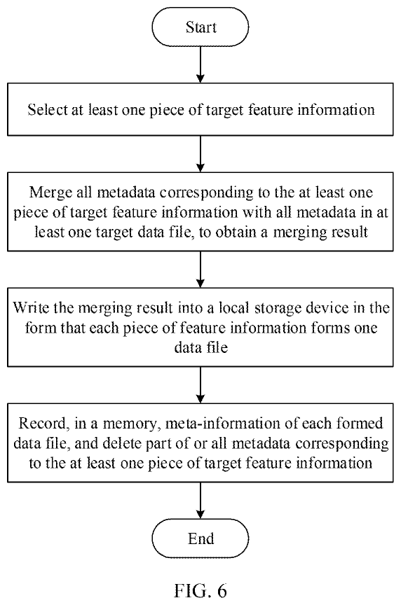

Referring to FIG. 6, FIG. 6 illustratively shows a metadata persistence process described in the implementations, and in this process, all metadata corresponding to one or more pieces of feature information is flushed to disk.

In a database system of a storage-shared architecture, persistently cached data in a database node needs to be updated according to service needs, that is, the persistently cached data is updated in real time according to current user access needs by deleting old data and utilizing space released by the old data to cache new data.

In some implementations of this specification, when the cached data in the database node is deleted, a state record of the metadata of the cached data can be managed in the following methods.

Case 1: If any data in the cached data is deleted by the database node, and the metadata of the data is recorded in the memory, a state of the metadata of the data in the memory is updated from normal to deleted.

Case 2: If any data in the cached data is deleted by the database node, the metadata of the data is not recorded in the memory, and the metadata of the data is recorded in the local storage device, the metadata of the data is inserted into the memory, and a state of the metadata of the data is marked as deleted.

For example, it is possible to determine whether metadata of the deleted data exists in the memory by searching the memory using a key of the deleted data, that is, whether metadata having the same key exists.

For example, it is possible to determine whether metadata of the deleted data exists in the local storage device by searching the local storage device using a key of the deleted data. Specifically, key ranges recorded in meta-information of data files in the memory are first used to determine whether there is any data file whose key range covers the key of the data. If no such data file exists, it is determined that the metadata of the data is not recorded in the local storage device. If such a data file exists, each data file whose key range covers the key of the data is searched to determine whether the metadata of the data exists, i.e., whether metadata having the same key exists.

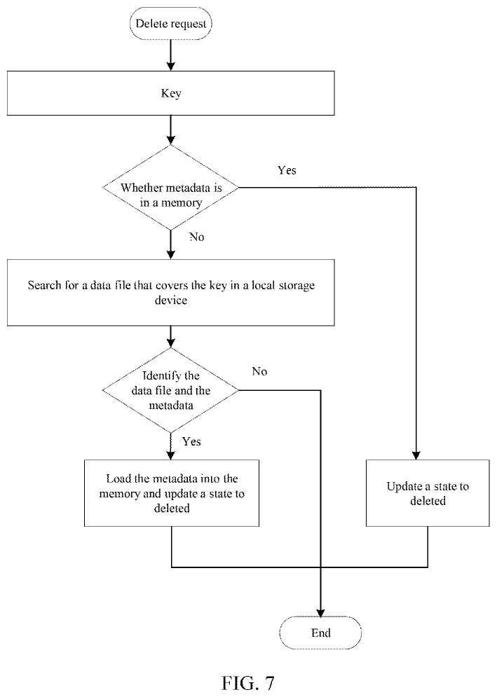

Referring to FIG. 7, FIG. 7 illustratively shows a metadata deleting process described in the implementations.

In some implementations of this specification, when the cached data is written to the database node, the metadata of the cached data can be written to the memory in the following methods.

Case 1: A write request used to indicate to write metadata of any data is received, and if the metadata of the data is recorded in the memory with a state of deleted, the metadata of the data is inserted into the memory, and the state of the metadata of the data is marked as normal. A metadata state of original data in the memory is deleted with its content being empty, and is invalid metadata. Thus, metadata of the data can be directly re-inserted into the memory, and a state of the metadata is marked as normal. The metadata is inserted into the content, for example, the metadata of the data is added to the level-2 map shown in FIG. 3.

Case 2: A write request used to indicate to write metadata of any data is received, and if the metadata of the data is recorded in the memory with a state of normal, content of the metadata of the data in the memory is updated. If a metadata state of original data in the memory is normal, metadata of the data is valid metadata, and thus, content of the metadata can be directly updated to new metadata of the data, that is, metadata content indicated by the current write request. An execution method described in this case is also applicable to a metadata updating process of data.

Case 3: A write request used to indicate to write metadata of any data is received, and if the metadata of the data is not recorded in the memory, and the metadata of the data is recorded in the local storage device, the metadata of the data is loaded into the memory, and content of the metadata of the data is updated. It can be determined from the above-mentioned implementations that a state of metadata persisted in the local storage device is normal, because metadata with a state of deleted does not appear in the above-mentioned merging result. Thus, metadata that is recorded in the local storage device but not in the memory has been persisted to the local storage device in the above-described method for the purpose of releasing memory space. Accordingly, the metadata can be loaded into the memory, and the content of the metadata can be updated in the method described in Case 2. An execution method described in this case is also applicable to a metadata updating process of data.

Case 4: A write request used to indicate to write metadata of any data is received, and if the metadata of the data is neither recorded in the memory nor recorded in the local storage device, the metadata of the data is inserted into the memory, and a state of the metadata of the data is marked as normal. Metadata that is recorded in neither the memory nor the local storage device corresponds to a first-time write. Thus, the metadata of the data can be directly inserted into the memory, the state of the metadata is marked as normal, and the metadata is inserted into the content, for example, by adding the metadata of the data into the two-level map shown in FIG. 3.

For example, it is possible to determine whether metadata of the written data exists in the memory by searching the memory using a key of the deleted data, that is, whether metadata having the same key exists.

For example, it is possible to determine whether metadata of the written data exists in the local storage device by searching the local storage device using a key of the deleted data. Specifically, key ranges recorded in meta-information of data files in the memory are first used to determine whether there is any data file whose key range covers the key of the data. If no such data file exists, it is determined that the metadata of the data is not recorded in the local storage device. If such a data file exists, each data file whose key range covers the key of the data is searched to determine whether the metadata of the data exists, i.e., whether metadata having the same key exists.

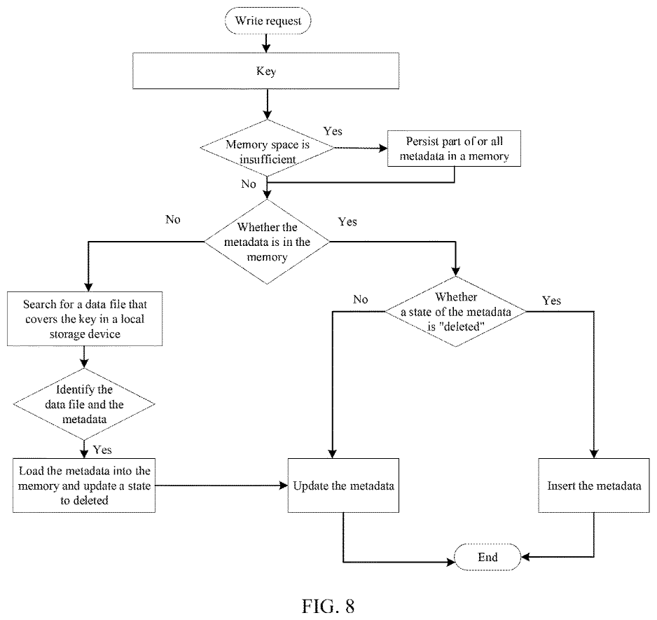

Referring to FIG. 8, FIG. 8 illustratively shows a metadata writing process described in the implementations.

In some implementations of this specification, the metadata of the cached data can be read by using the following methods:
Case 1: A read request used to indicate to write metadata of any data is received, and if the metadata of the data is recorded in a memory with a state of normal, and the metadata of the data is recorded in the local storage device, the metadata of the data in the memory is read.
Case 2: A read request used to indicate to write metadata of any data is received, and if the metadata of the data is recorded in the memory with a state of normal, and the metadata of the data is not recorded in the local storage device, the metadata of the data in the memory is read.
Case 3: A read request used to indicate to write metadata of any data is received, and if the metadata of the data is recorded in the memory with a state of deleted, and the metadata of the data is recorded in the local storage device, the metadata of the data is loaded from the local storage device into the memory and then read.
Case 4: A read request used to indicate to write metadata of any data is received, and if the metadata of the data is recorded in the memory with a state of deleted, and the metadata of the data is not recorded in the local storage device, absence of the metadata of the data is reported.

For example, it is possible to determine whether the metadata of the data exists in the memory based on a key of the data being read, i.e., whether metadata having the same key exists.

For example, it is possible to determine whether metadata of the read data exists in the local storage device by searching the local storage device using a key of the deleted data. Specifically, key ranges recorded in meta-information of data files in the memory are first used to determine whether there is any data file whose key range covers the key of the data. If no such data file exists, it is determined that the metadata of the data is not recorded in the local storage device. If such a data file exists, each data file whose key range covers the key of the data is searched to determine whether the metadata of the data exists, i.e., whether metadata having the same key exists.

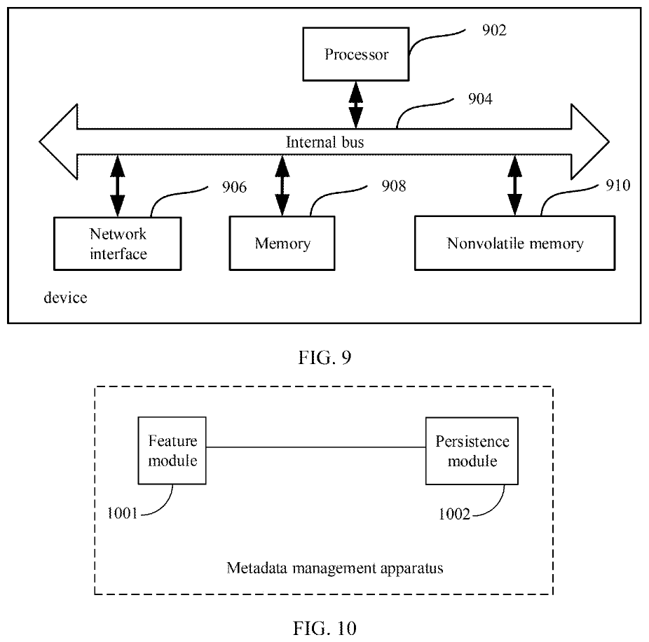

FIG. 9 is a schematic diagram illustrating a structure of a device, according to one or more exemplary implementations. As shown in FIG. 9, at a hardware level, the device includes a processor 902, an internal bus 904, a network interface 906, a memory 908, and a nonvolatile memory 910, and certainly may further include other hardware needed by a service. One or more implementations of this specification can be implemented in a software-based way. For example, the processor 902 reads a corresponding computer program from the nonvolatile memory 910 into the memory 908, and then runs the computer program. Certainly, in addition to a software implementation, one or more implementations of this specification do not exclude another implementation, for example, a logic device or a combination of hardware and software. That is, an execution body of the following processing procedure is not limited to each logical unit, and can be hardware or a logic device.

As shown in FIG. 10, a metadata management apparatus can be applied to the device shown in FIG. 9, to implement the technical solutions in this specification. The metadata management apparatus can include the following: a feature module 1001, configured to write metadata of each piece of data in cached data into a memory, and record, in the memory, feature information of the metadata of each piece of data in the cached data, where the cached data is data loaded by a storage sharing layer to the database node, and the metadata is used to record at least one piece of meta-information of corresponding data; and a persistence module 1002, configured to: when flushing the metadata to a local storage device, obtain metadata with the same feature information, and aggregate and write the metadata with the same feature information to the local storage device, where data corresponding to the metadata with the same feature information has the same data feature.

In one or more possible implementations of this specification, the feature module is configured to record, in the memory, a mapping relationship between the feature information and a key of the metadata.

In one or more possible implementations of this specification, the persistence module is configured to: determine part of feature information in all feature information as target feature information based on a predetermined cycling condition and feature information of metadata that is transferred from the memory to the local storage device at a previous time; and aggregate and write all metadata corresponding to each piece of target feature information to the local storage device.

In one or more possible implementations of this specification, the persistence module is configured to: determine part of feature information in all feature information as target feature information based on currently idle space of the memory and a data amount of metadata corresponding to each piece of feature information; and aggregate and write all metadata corresponding to each piece of target feature information to the local storage device.

In one or more possible implementations of this specification, the persistence module is configured to generate a data file from the metadata with the same feature information, write the data file to the local storage device, and record meta-information of the data file in the memory.

In one or more possible implementations of this specification, when the persistence module is configured to generate the data file by using metadata with the same feature information and write the data file to the local storage device, the persistence module is configured to: merge all metadata corresponding to the feature information with a target data file in the local storage device to obtain a merging result, where the target data file is a data file that stores metadata already flushed to disk corresponding to the feature information, and the merging result includes metadata of a plurality of pieces of data; generate a data file from all metadata in the merging result, and write the data file to the local storage device; and delete the target data file, and delete part of or all metadata corresponding to the feature information in the memory.

In one or more possible implementations of this specification, the metadata records a state, and the state includes normal and deleted; and when the persistence module is configured to merge all metadata corresponding to the feature information with a target data file in the local storage device to obtain a merging result, the persistence module is configured to: if metadata of any data is recorded in the memory with a state of normal, and the metadata of the data is recorded in the target data file, add the metadata of the data in the memory to the merging result; if metadata of any data is recorded in the memory with a state of normal, and the metadata of the data is not recorded in the target data file, add the metadata of the data in the memory to the merging result; if metadata of any data is recorded in the memory with a state of deleted, and the metadata of the data is recorded in the target data file, determine that the metadata of the data does not belong to the merging result; if metadata of any data is recorded in the memory with a state of deleted, and the metadata of the data is not recorded in the target data file, add the metadata of the data in the memory to the merging result; or if metadata of any data is not recorded in the memory, and the metadata of the data is recorded in the target data file, add the metadata of the data in the target data file to the merging result.

In one or more possible implementations of this specification, the apparatus further includes a deleting module, configured to: if any data in the cached data is deleted by the database node, and the metadata of the data is recorded in the memory, update a state of the metadata of the data in the memory from normal to deleted; and if any data in the cached data is deleted by the database node, the metadata of the data is not recorded in the memory, and the metadata of the data is recorded in the local storage device, insert the metadata of the data into the memory, and mark a state of the metadata of the data as deleted.

In one or more possible implementations of this specification, the apparatus further includes a writing module, configured to: receive a write request used to indicate to write metadata of any data, and if the metadata of the data is recorded in the memory with a state of deleted, insert the metadata of the data into the memory, and mark a state of the metadata of the data as normal; receive a write request used to indicate to write metadata of any data, and if the metadata of the data is recorded in the memory with a state of normal, update content of the metadata of the data in the memory; receive a write request used to indicate to write metadata of any data, and if the metadata of the data is not recorded in the memory, and the metadata of the data is recorded in the local storage device, load the metadata of the data into the memory, and update content of the metadata of the data; and receive a write request used to indicate to write metadata of any data, and if the metadata of the data is not recorded in the memory, and the metadata of the data is not recorded in the local storage device, insert the metadata of the data into the memory, and mark a state of the metadata of the data as normal.

In one or more possible implementations of this specification, the feature information includes a value of the data in at least one feature dimension.

According to one or more implementations of this specification, a computer program product is provided and includes a computer program/instructions. When the computer program/instructions is/are executed by a processor, the steps of the method according to the first aspect are implemented.

According to one or more implementations of this specification, a computer-readable storage medium is provided, where computer instructions are stored on the computer-readable storage medium, and the instructions are executed by a processor to implement the steps of the method according to the first aspect.

The system, apparatus, module, or unit described in the above-mentioned implementations can be specifically implemented by a computer chip or an entity, or can be implemented by a product having a certain function. A typical implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

In a typical configuration, the computer includes one or more processors (CPU), one or more input/output interfaces, one or more network interfaces, and one or more memories.

The memory may include a non-permanent memory, a random access memory (RAM), a nonvolatile memory, and/or the like in a computer readable medium, such as a read-only memory (ROM) or a flash RAM. The memory is an example of the computer-readable medium.

The computer-readable medium includes persistent, non-persistent, removable, and non-removable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD), or another optical storage, a cassette, a disk memory, a quantum memory, a graphene-based storage medium, another magnetic storage device, or any other non-transmission medium. The computer storage medium may be configured to store information that can be accessed by a computing device. Based on the definition in this specification, the computer-readable medium does not include transitory media such as a modulated data signal and carrier.

It should further be noted that, the terms “comprise”, “include” and any other variants thereof are intended to cover non-exclusive inclusion, so that a process, a method, a product, or a device that includes a series of elements not only includes these very elements, but may also include other elements not expressly listed, or also include elements inherent to this process, method, product, or device. Without more constraints, an element preceded by “includes a . . . ” does not preclude the existence of additional identical elements in the process, method, product, or device that includes the element.

Specific implementations of this specification are described previously. Other implementations fall within the scope of the appended claims. In some cases, the actions or steps described in the claims can be performed in an order different from that in the implementations and desired results can still be achieved. In addition, the process depicted in the accompanying drawings does not necessarily need a particular sequence or consecutive sequence to achieve the desired results. In some implementations, multitasking and parallel processing are feasible or may be advantageous.

Terms used in one or more implementations of this specification are merely used to describe specific implementations, and are not intended to limit the one or more implementations of this specification. The terms “a” and “the” of singular forms used in one or more implementations of this specification and the appended claims are also intended to include plural forms, unless otherwise specified in the context clearly. It should be further understood that the term “and/or” used in this specification indicates and includes any or all possible combinations of one or more associated listed items.

User information (including but not limited to user device information, personal information of a user, etc.) and data (including but not limited to data used for analysis, stored data, displayed data, etc.) used in this specification are information and data that are authorized by the user or fully authorized by each party, related data needs to be collected, used, and processed by abiding by related laws and regulations and standards of a related country and region, and a corresponding operation entry is provided, so that the user chooses to perform authorization or rejection.

It should be understood that although terms “first”, “second”, “third”, etc. may be used in one or more implementations of this specification to describe various types of information, the information is not limited to these terms. These terms are merely used to differentiate between information of the same type. For example, without departing from the scope of one or more implementations of this specification, first information can also be referred to as second information, and similarly, the second information can be referred to as the first information. Depending on the context, for example, the word “if” used here can be explained as “while”, “when”, or “in response to determining”.

The above-mentioned descriptions are only exemplary implementations of one or more implementations of this specification, but are not intended to limit the one or more implementations of this specification. Any modification, equivalent replacement, improvement, etc. made without departing from the spirit and principle of the one or more implementations of this specification shall fall within the protection scope of the one or more implementations of this specification.

What is claimed is:

1. A computer-implemented method for metadata management, wherein the computer-implemented method is applied to a database node, and the computer-implemented method comprises:
writing metadata of each piece of data in cached data into a memory;
recording, in the memory, feature information of the metadata of each piece of data, wherein the cached data is data loaded by a storage sharing layer to the database node, and the metadata records at least one piece of meta-information of corresponding data; and
flushing the metadata to a local storage device, wherein the flushing comprises:
obtaining metadata with same feature information; and
aggregating and writing the metadata with the same feature information to the local storage device, wherein data corresponding to the metadata with the same feature information has a same data feature.

2. The computer-implemented method of claim 1, wherein recording, in the memory, the feature information of the metadata of each piece of data in the cached data comprises:
recording, in the memory, a mapping relationship between the feature information and a key of the metadata.

3. The computer-implemented method of claim 1, wherein aggregating and writing the metadata with the same feature information to the local storage device comprises:
determining a part of all recorded feature information as a plurality of pieces of target feature information based on a predetermined cycling condition and feature information of metadata that is transferred from the memory to the local storage device at a previous time; and
aggregating and writing all metadata corresponding to each piece of target feature information to the local storage device.

4. The computer-implemented method of claim 1, wherein aggregating and writing the metadata with the same feature information to the local storage device comprises:
determining a part of all recorded feature information as a plurality of pieces of target feature information based on currently idle space of the memory and a data amount of metadata corresponding to each piece of feature information; and
aggregating and writing all metadata corresponding to each piece of target feature information to the local storage device.

5. The computer-implemented method of claim 1, wherein aggregating and writing the metadata with the same feature information to the local storage device comprises:
generating a data file from the metadata with the same feature information;
writing the data file to the local storage device; and
recording meta-information of the data file in the memory.

6. The computer-implemented method of claim 5, wherein generating the data file from the metadata with the same feature information and writing the data file to the local storage device comprises:
merging all metadata corresponding to the feature information with a target data file in the local storage device to obtain a merging result, wherein the target data file stores metadata already flushed to disk corresponding to the feature information, and the merging result comprises metadata of a plurality of pieces of data;
generating the data file from all metadata in the merging result;
writing the data file to the local storage device; and
deleting the target data file and at least a part of metadata corresponding to the feature information in the memory.

7. The computer-implemented method of claim 6, wherein the metadata records a state, and the state comprises normal or deleted, and wherein merging all metadata corresponding to the feature information with the target data file in the local storage device to obtain the merging result comprises:
if metadata of any data is recorded in the memory with a state of normal, and the metadata of the data is recorded in the target data file, adding the metadata of the data in the memory to the merging result;
if metadata of any data is recorded in the memory with a state of normal, and the metadata of the data is not recorded in the target data file, adding the metadata of the data in the memory to the merging result;
if metadata of any data is recorded in the memory with a state of deleted, and the metadata of the data is recorded in the target data file, determining that the metadata of the data does not belong to the merging result;
if metadata of any data is recorded in the memory with a state of deleted, and the metadata of the data is not recorded in the target data file, adding the metadata of the data in the memory to the merging result; or
if metadata of any data is not recorded in the memory, and the metadata of the data is recorded in the target data file, adding the metadata of the data in the target data file to the merging result.

8. The computer-implemented method of claim 7, comprising:
if any data in the cached data is deleted by the database node, and the metadata of the data is recorded in the memory, updating a state of the metadata of the data in the memory from normal to deleted; or
if any data in the cached data is deleted by the database node, the metadata of the data is not recorded in the memory, and the metadata of the data is recorded in the local storage device, inserting the metadata of the data into the memory, and marking a state of the metadata of the data as deleted.

9. The computer-implemented method of claim 7, comprising:
receiving a write request indicating to write metadata of any data; and
if the metadata of the data is recorded in the memory with a state of deleted, inserting the metadata of the data into the memory, and marking a state of the metadata of the data as normal;
if the metadata of the data is recorded in the memory with a state of normal, updating content of the metadata of the data in the memory;
if the metadata of the data is not recorded in the memory, and the metadata of the data is recorded in the local storage device, loading the metadata of the data into the memory, and updating content of the metadata of the data; or
if the metadata of the data is not recorded in the memory, and the metadata of the data is not recorded in the local storage device, inserting the metadata of the data into the memory, and marking a state of the metadata of the data as normal.

10. The computer-implemented method of claim 1, wherein the feature information comprises a value of the data in at least one feature dimension.

11. A non-transitory, computer-readable medium storing one or more instructions executable by a computer system to perform one or more operations for metadata management, the one or more operations comprising:
writing metadata of each piece of data in cached data into a memory;
recording, in the memory, feature information of the metadata of each piece of data, wherein the cached data is data loaded by a storage sharing layer to a database node, and the metadata records at least one piece of meta-information of corresponding data; and
flushing the metadata to a local storage device, wherein the flushing comprises:
obtaining metadata with same feature information; and
aggregating and writing the metadata with the same feature information to the local storage device, wherein data corresponding to the metadata with the same feature information has a same data feature.

12. The non-transitory, computer-readable medium of claim 11, wherein recording, in the memory, the feature information of the metadata of each piece of data in the cached data comprises:
recording, in the memory, a mapping relationship between the feature information and a key of the metadata.

13. The non-transitory, computer-readable medium of claim 11, wherein aggregating and writing the metadata with the same feature information to the local storage device comprises:
determining a part of all recorded feature information as a plurality of pieces of target feature information based on a predetermined cycling condition and feature information of metadata that is transferred from the memory to the local storage device at a previous time; and
aggregating and writing all metadata corresponding to each piece of target feature information to the local storage device.

14. The non-transitory, computer-readable medium of claim 11, wherein aggregating and writing the metadata with the same feature information to the local storage device comprises:
determining a part of all recorded feature information as a plurality of pieces of target feature information based on currently idle space of the memory and a data amount of metadata corresponding to each piece of feature information; and
aggregating and writing all metadata corresponding to each piece of target feature information to the local storage device.

15. The non-transitory, computer-readable medium of claim 11, wherein aggregating and writing the metadata with the same feature information to the local storage device comprises:
generating a data file from the metadata with the same feature information;
writing the data file to the local storage device; and
recording meta-information of the data file in the memory.

16. The non-transitory, computer-readable medium of claim 15, wherein generating the data file from the metadata with the same feature information and writing the data file to the local storage device comprises:
merging all metadata corresponding to the feature information with a target data file in the local storage device to obtain a merging result, wherein the target data file stores metadata already flushed to disk corresponding to the feature information, and the merging result comprises metadata of a plurality of pieces of data;
generating the data file from all metadata in the merging result;
writing the data file to the local storage device; and
deleting the target data file and at least a part of metadata corresponding to the feature information in the memory.

17. The non-transitory, computer-readable medium of claim 16, wherein the metadata records a state, and the state comprises normal or deleted, and wherein merging all metadata corresponding to the feature information with the target data file in the local storage device to obtain the merging result comprises:
if metadata of any data is recorded in the memory with a state of normal, and the metadata of the data is recorded in the target data file, adding the metadata of the data in the memory to the merging result;
if metadata of any data is recorded in the memory with a state of normal, and the metadata of the data is not recorded in the target data file, adding the metadata of the data in the memory to the merging result;
if metadata of any data is recorded in the memory with a state of deleted, and the metadata of the data is recorded in the target data file, determining that the metadata of the data does not belong to the merging result;
if metadata of any data is recorded in the memory with a state of deleted, and the metadata of the data is not recorded in the target data file, adding the metadata of the data in the memory to the merging result; or
if metadata of any data is not recorded in the memory, and the metadata of the data is recorded in the target data file, adding the metadata of the data in the target data file to the merging result.

18. The non-transitory, computer-readable medium of claim 17, the one or more operations comprising:
if any data in the cached data is deleted by the database node, and the metadata of the data is recorded in the memory, updating a state of the metadata of the data in the memory from normal to deleted; or
if any data in the cached data is deleted by the database node, the metadata of the data is not recorded in the memory, and the metadata of the data is recorded in the local storage device, inserting the metadata of the data into the memory, and marking a state of the metadata of the data as deleted.

19. The non-transitory, computer-readable medium of claim 17, the one or more operations comprising:
receiving a write request indicating to write metadata of any data; and
if the metadata of the data is recorded in the memory with a state of deleted, inserting the metadata of the data into the memory, and marking a state of the metadata of the data as normal;
if the metadata of the data is recorded in the memory with a state of normal, updating content of the metadata of the data in the memory;
if the metadata of the data is not recorded in the memory, and the metadata of the data is recorded in the local storage device, loading the metadata of the data into the memory, and updating content of the metadata of the data; or
if the metadata of the data is not recorded in the memory, and the metadata of the data is not recorded in the local storage device, inserting the metadata of the data into the memory, and marking a state of the metadata of the data as normal.

20. A computer-implemented system for metadata management, comprising:
one or more computers; and
one or more computer memory devices interoperably coupled with the one or more computers and having tangible, non-transitory, machine-readable media storing one or more instructions that, when executed by the one or more computers, perform one or more operations comprising:
writing metadata of each piece of data in cached data into a memory;
recording, in the memory, feature information of the metadata of each piece of data, wherein the cached data is data loaded by a storage sharing layer to a database node, and the metadata records at least one piece of meta-information of corresponding data; and
flushing the metadata to a local storage device, wherein the flushing comprises:
obtaining metadata with same feature information; and
aggregating and writing the metadata with the same feature information to the local storage device, wherein data corresponding to the metadata with the same feature information has a same data feature.
